(19) United States
(12) Patent Application Publication
(10) Pub. No.: US 2019/0210451 A1
(43) Pub. Date: Jul. 11, 2019

(54) Device For Opening And Closing Flaps

(71) Applicant: Compagnie Plastic Omnium, Lyon (FR)

(72) Inventors: Stéphane Parra, Vaulx-En-Velin (FR); Bertrand Mazue, Lyon (FR); Julien Jacomy, Morestel (FR)

(21) Appl. No.: 16/095,474

(22) PCT Filed: Apr. 10, 2017
(86) PCT No.: PCT/FR2017/050854

§ 371 Date: Mar. 28, 2019

(30) Foreign Application Priority Data
Apr. 22, 2016 (FR) 1653569

(51) Int. Cl. B60K 11/08; B60K 11/06

(52) U.S. Cl. CPC B60K 11/085; B60K 11/06

(57) ABSTRACT

A device for maneuvering one or more sets of flaps formed of one or more flaps, each flap pivoting about an axis of rotation (a1a1′, b1b1′, c1c1′, d1d1′, a2a2′, b2b2′, c2c2′, d2d2′) mounted on a chassis. The flaps of a set of flaps are set in rotation by at least one activating plate that moves in translation between two end positions in a main direction (YY′) substantially perpendicular to the axes of the flaps, the activating plate having guide slots, each of the guide slots engaging with a finger disposed on a set of link rods mounted on an upper edge and/or lower edge of each of the flaps of the set, such that movement of the activating plate between the end positions in one direction and in an opposite direction causes each of the flaps of the set of flaps to open and close, respectively.

### FIELD OF THE INVENTION

The invention relates to a mechanical device for deploying and retracting one or more sets of flaps used in motor vehicles.

### BACKGROUND OF THE INVENTION

These flaps are used for example to change the conditions for allowing air to enter an engine compartment and improve the heat exchanges, or hide or show a driving aid technical device such as a laser. These numerous features may be required simultaneously or independently of each other.

Furthermore, it is preferred to implement a plurality of flaps each having a reduced surface, in order to distribute over a larger number of flaps the aerodynamic forces exerted on their surfaces when the vehicle travels at high speed. Since the flaps are smaller, the space required for their angular displacement is also reduced.

The flaps may also participate in the overall style of the bodywork, and are in this case visible from outside the vehicle.

When the flaps are used to regulate the flow of ambient air, a device controls the opening angle of the flaps according to the driving parameters so as to regulate the volume of incoming air.

Similarly, when the purpose of a flat is to hide a driving aid technical device, the flap opens for example when the vehicle starts and closes when the engine is switched off, or during any other request from the vehicle control unit.

Numerous flap opening and closing devices exist.

These mechanisms are often complex and do not allow several features to be implemented easily, unless one mechanism is provided for each feature.

### SUMMARY OF THE INVENTION

The object of the invention is to propose a simplified mechanism allowing modular use, and therefore easily adaptable to several features at low cost.

This device for maneuvering a set of flaps formed of one or more flaps, each flap pivoting about an axis of rotation mounted on a chassis, the flaps of a set of flaps being set in rotation by at least one activating plate that moves in translation between two end positions along a linear path located in a plane substantially perpendicular to the axes of the flaps and forming a main direction, said activating plate having guide slots, each of the guide slots engaging with a finger disposed on a set of link rods mounted on an upper edge and/or a lower edge of each of the flaps of said set. The one or more activating plates are driven in translation by at least one drive cable forming a closed loop and circulating along the lower edges and/or upper edges of the flaps such that the movement of an activating plate between said end positions in one direction and in an opposite direction causes each of the flaps of said set of flaps to open and close respectively such that the movement of the activating plate between said end positions in one direction and in an opposite direction causes each of the flaps of said set of flaps to open and close respectively.

It is thus possible to obtain means for simultaneous driving in two opposite directions depending on whether we consider the drive cable on its outwards path or on its return path. By judiciously arranging the cable path using for example return pulleys, it is possible to set in translation one or more activating plates disposed according to requirements on the lower edges and/or upper edges of the flaps or activating plates belonging to different sets of flaps. As will be seen below, numerous alternative embodiments are possible by adapting for example the shape of the guide slots to adapt the flap opening power or to allow the device to be used on vehicles travelling at high speed, or to increase the number of sets of flaps forming the device to meet style criteria.

The maneuvering device according to the invention may also comprise, separately or in combination, the following characteristics:
Each guide slot comprises two linear longitudinal sections parallel to the main direction, separated from each other by a given non-zero value, and connected to each other by a transverse section forming a ramp making a given angle with said main direction.
The positions in the main direction and the angles of inclination of the ramps of each of the guide slots are arranged so that each of the fingers engages in the ramp of the guide slot with which it cooperates between two positions of the activating plate defined beforehand for each of the flaps of a set, such that the flaps of said set open and close in a predetermined order.
A set of link rods is formed of a primary link rod hinged about a first pin mounted on the upper edge and/or lower edge of the flap, and of a secondary link rod supporting the finger and connected to the primary link rod by a hinge pivoting freely about a second pin, the first and second hinge pins of the link rods being substantially parallel to the axis of rotation of the flap on which the set of link rods is mounted.
The activating plate moves between its two end positions along a linear path having a radius of curvature.
The activating plate also has a radius of curvature identical to that of the path on which it circulates.
The one or more drive cables perform at least one full turn in a given direction around one or more motorized pulleys, such that rotating one or more of said motorized pulleys drives in translation one or more activating plates.
The flaps of a set of flaps are set in rotation by an upper activating plate and a lower activating plate moving in the main direction, and each cooperating with sets of link rods respectively connected to the upper edge and the lower edge of each of the flaps of said set of flaps.
The upper activating plate of a set of flaps and the lower activating plate of the same set of flaps are connected to a single drive cable or to a first drive cable and a second drive cable such that, when the one or more motorized pulleys are set in rotation, the upper activating plate and the lower activating plate of said set of flaps circulate in the same direction in the main direction.
The maneuvering device according to one of the claims comprises two sets of flaps separate from each other, each of the flaps of a set pivoting on its respective axis in a direction of rotation opposite to the direction of rotation of the flaps of the other set.
A set of flaps is formed of one or more pairs of half-flaps each formed of a first half-flap and a second half-flap each pivoting on an axis in opposite directions to each other, each half-flap comprising one or more panels arranged such that, when the pair of half-flaps is in the closed position, the panels of the first half-flap hide a surface complementary to the surface hidden by the panels of the second half-flap.
The first half-flaps of a set formed of pairs of half-flaps are driven by the upper activating plate, and the second half-flaps of said set (1) formed of pairs of half-flaps are driven in rotation by the lower activating plate.

### BRIEF DESCRIPTION OF THE DRAWINGS

The invention will be better understood on reading the accompanying figures, which are given solely by way of example and not limiting in any way, in which:

FIG. 1 is a perspective view showing two sets of flaps in the open position.

FIG. 2 is a partial perspective view showing a first set of flaps in the closed position.

FIG. 3 is a perspective view showing the activating plates and the drive cables of the two sets of flaps.

FIG. 4 is a top view of the sets of link rods.

FIG. 5 is a partial perspective view showing the first set of flaps in the open position.

FIGS. 6a, 6b, 6c, 6d and 6e show guide slots of various shapes.

FIGS. 7, 7a, 8, 8a, 9, 9a, 10, 10a, 11, 11a, 12 and 12a show the movements of the flaps according to the steps of the movement of the activating plate.

FIGS. 13, 14 and 15 show examples of half-flaps.

FIGS. 16, 17, 18, 19, 20, 21, 22 and 23 show different circulation variants of the drive cable.

### DETAILED DESCRIPTION OF THE INVENTION

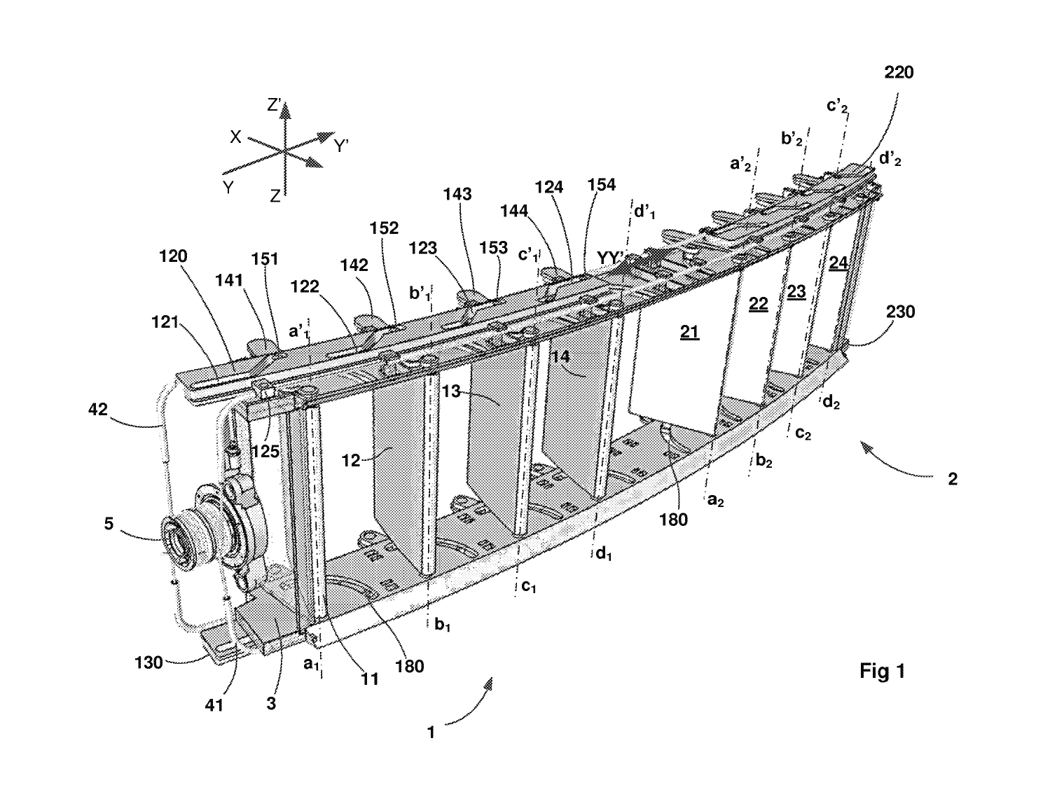

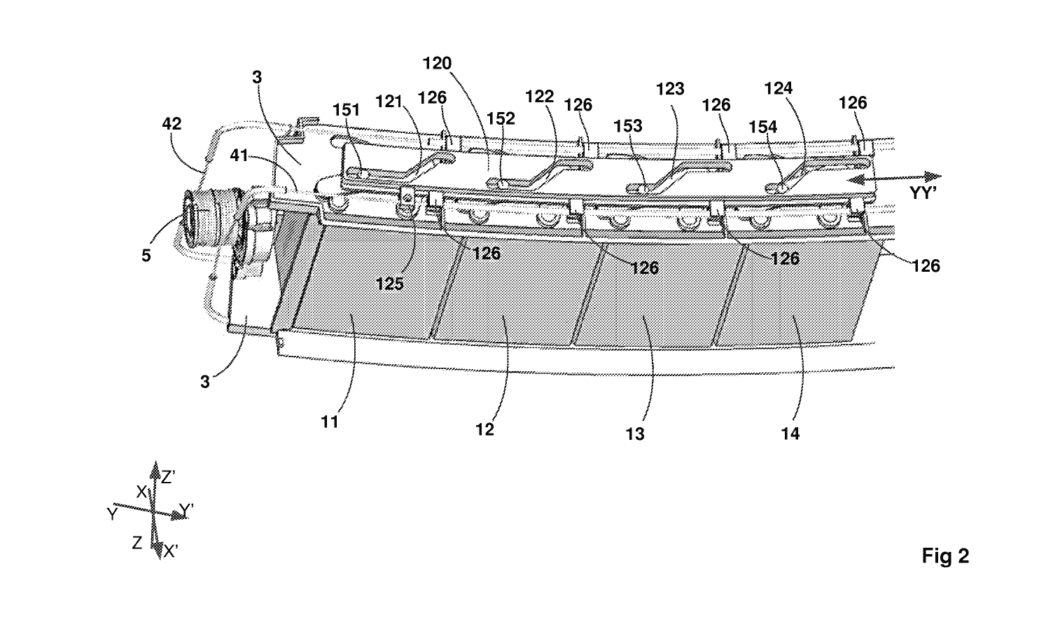

The maneuvering device illustrated in perspective on FIGS. 1 and 2, comprises a first set of flaps 1, formed of four flaps 11, 12, 13, 14, and a second set of flaps 2, also formed of four flaps 21, 22, 23 and 24. These flaps are mounted on a chassis 3 and pivot freely about the axes of rotation a₁a₁′, b₁b₁′, c₁c₁′, d₁d₁′, a₂a₂′, b₂b₂′, c₂c₂′, d₂d₂′ respectively. In a non-limiting way, the axes of rotation are oriented by convention in the direction ZZ′ generally representing the vertical direction in the vehicle coordinate system. Obviously, it is quite possible, without departing from the object of the invention, to orient the coordinate system OXYZ according to the positioning requirements for the maneuvering device in the vehicle. The axes of rotation of the flaps can therefore be indifferently oriented in the vertical, horizontal position or any other direction deemed adequate by the vehicle designer.

To simplify the following description, the detailed explanations of the mechanism will concern the upper part of the first set of flaps, assuming that the mechanisms of the lower part or that of the second set of flaps are symmetrical with the upper mechanism of the first set with respect to an equatorial plane (OXY) or with respect to a median plane (OZX).

The flaps of the first set 1 are driven in rotation by an upper activating plate 120. The flaps of the second set are driven by the upper activating plate 220.

The upper activating plate 120 comprises guide slots 121, 122, 123, 124 engaging respectively with fingers 151, 152, 153 and 154 mounted on sets of link rods 141, 142, 143 and 144. As will be described in detail below, these sets of link rods are used to set the flaps in rotation when the activating plate circulates in the main direction YY′.

The linear path of the activating plate may be straight or have a slight radius of curvature, preferably constant, to match the shape of the vehicle. This radius of curvature may range from a few tens of centimeters to 2 or 3 meters, depending on the style requirements imposed on the vehicle in the immediate vicinity of the maneuvering device.

Under these conditions, the activating plate may also have a radius of curvature identical to that of the path which it has to follow.

The upper activating plate 120 is moved by a first drive cable 41 circulating in a closed loop along the upper part and the lower part of the flaps. It is connected to the first cable 41 by an attachment point 125.

In the present case, the term cable refers to any means of transmitting forces such as a cable made of metal or synthetic fibers, but also any equivalent means such as a chain, a belt, a toothed belt, or a flexible blade.

The first cable 41 performs at least one full turn in a first direction around a motorized pulley 5. In this way, when the motorized pulley turns in a first direction, the activating plate 120 circulates in the direction YY′ and, when the pulley 5 turns in the opposite direction, the activating plate 120 circulates in the direction Y′Y.

FIG. 1 shows that all the flaps are in the open position, the maneuvering plate then occupies one of its end positions and the fingers are located at one end of the guide slot with which they engage. FIG. 2 shows the flaps in the closed position and the activating plate 120 disposed at its other end position. The fingers are then located at the other end of the guide slot.

When the vehicle is intended to travel at high speed, it becomes necessary to increase the power of the drive members used when opening or closing due to the aerodynamic forces applied to the flaps. Under these conditions, to overcome higher aerodynamic forces and to improve the rotation of the flaps, it may be useful to have a second lower activating plate 130 comprising guide slots engaging with fingers mounted on link rods (not visible). The opening and closing torques therefore apply to both ends of the axis about which the flaps pivot. This lower activating plate 130 moves the flaps 11, 12, 13 and 14 using a set of link rods mounted on the lower edge of the flaps (partially visible).

A second drive cable 42, also circulating in a closed loop along the upper part and the lower part of the flaps drives the lower activating plate 130 in translation along the main direction YY′. The second drive cable 42 also performs a full turn around the motorized pulley 5 in a second direction opposite to the first direction performed by the first cable 41 around said pulley 5.

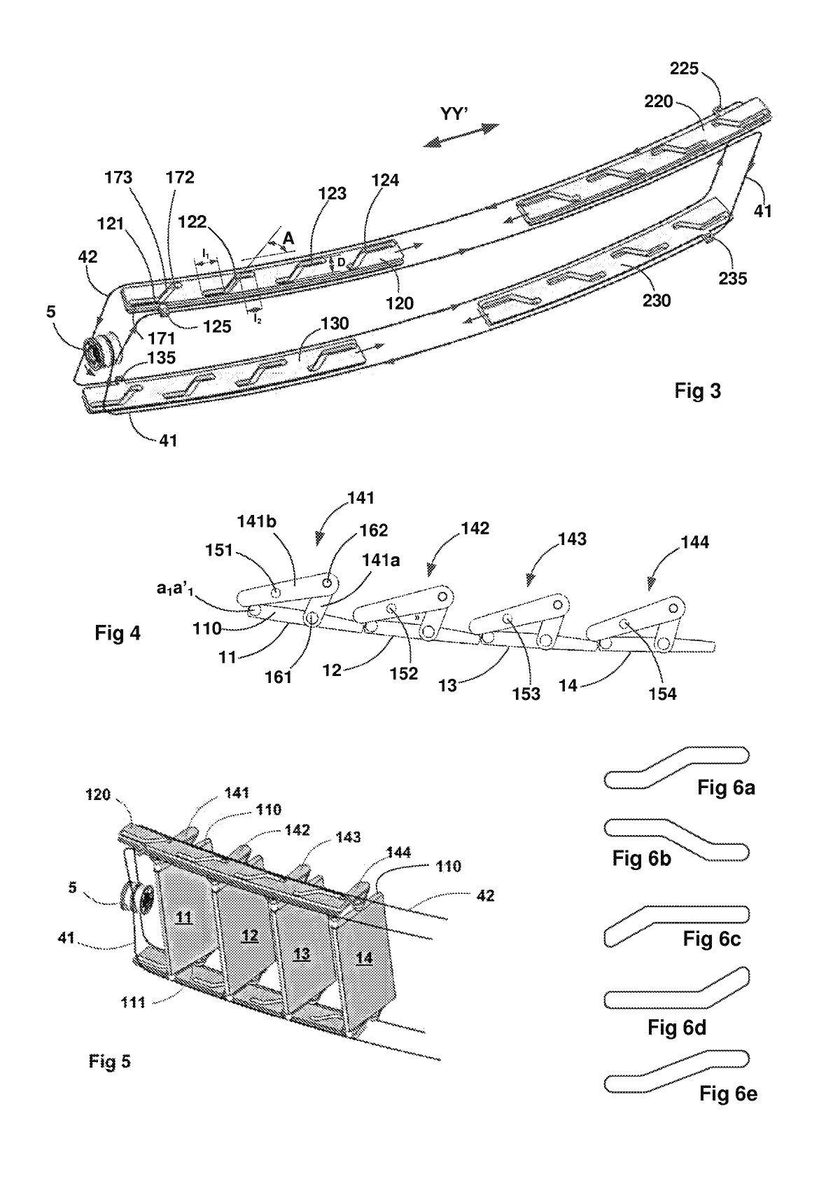

The lower activating plate 130 is connected to the second drive cable 42 by an attachment point 135 (not visible on FIG. 1, and visible on FIG. 3).

In this way, when the motorized pulley turns in one direction, the activating plates 120 and 130 move in the same direction in the direction YY′.

This arrangement comprising two drive cables each performing a full turn in opposite directions around the motorized pulley can also be used, with a single motor, to move the activating plates 120 and 130 forward synchronously, and to apply the motor torque simultaneously on the axes of the flaps to open and close them. This generates a non-negligible cost saving.

FIG. 2 shows more clearly how the activating plate and the drive cables 41 and 42 circulate on the upper part of the device. For this purpose, rails 126 are disposed on the chassis 3.

The upper activating plate 120 slides on the inner parts of the rails 126. The cables 41 and 42 are guided by notches made in the rails 126 to allow them to match the potential curve of the maneuvering device, when the latter has, as mentioned above, a radius of curvature to match the shape of a vehicle.

A second set of flaps 2, shown on FIG. 1, is moved by the activating plates 220 and 230. The upper activating plate 220 is connected to the second drive cable 42 by an attachment point 225 (visible on FIG. 3) and the lower activating plate 230 is connected to the first drive cable 41 by an attachment point 235 (visible on FIG. 3).

This arrangement can be used, when the motorized pulley 5 turns in a given direction, to circulate the upper 220 and lower 230 activating plates of the second set of flaps 2 in the direction YY′, in the direction opposite to the direction of circulation in the same direction, of the upper 120 and lower 130 activating plates of the first set of flaps 1.

This particular arrangement, made possible by the presence of the two drive cables 41 and 42 wound in opposite directions around the motorized pulley 5, can pivot the flaps of the second set 2, in a direction of rotation opposite to the direction of rotation of the flaps of the first set 1.

An alternative embodiment is also possible in which each set of flaps is driven in rotation by a single activating plate. Under these conditions, the first set of flaps 1 is driven in rotation by an upper activating plate 120, and the second set of flaps 2 is driven in rotation by a lower activating plate 230. We see that these two sets of flaps can be driven by a single drive cable.

Similarly, when the flaps of the two sets have to be opened by rotating all of them in a given direction of rotation, the two upper or lower activating plates can be connected to a single drive cable.

This is particularly useful, for example, when the style effects related to the axial symmetry of the vehicle front must be preserved.

FIG. 3 shows only the drive cables 41 and 42 to which the activating plates 120, 130, 220 and 230 are connected by the attachment points 125, 135, 225 and 235 respectively. When the motorized pulley turns in the direction indicated by the arrow, the drive cables circulate in the direction of the arrows and the activating plates circulate in opposite directions, moving towards the centre of symmetry of the device. Reversing the direction of rotation of the motorized pulley reverses the direction of movement of the activating plates.

FIG. 3 also shows a particular arrangement made possible by the shape of the guide slots 121, 122, 123 and 124 in which the fingers 151, 152, 153 and 154 (visible on FIG. 1 or FIG. 2) circulate.

Each of these guide slots has a first longitudinal section 171 extending in the main direction YY′, of length l₁, and a second longitudinal section 172 also extending in the direction YY′ and of length l₂. These two longitudinal sections are substantially parallel to one another and are separated from one another by a distance D, measured in this case in the direction XX′. They are connected together by a ramp 173 making an angle A with the main direction. This angle A is strictly less than 90° and preferably between 30° and 75°.

For obvious mechanical reasons, the length of the guide slot projected on the main direction is at least equal to the distance travelled by the activating plate between its two end positions.

As will be seen below, when crossing the ramp, the finger of the set of link rods drives, by the movement of the link rods, the rotation of the flap with which it is associated. When the finger is in a longitudinal section of the guide slot, the associated flap is in the fully open or fully closed position. Consequently, as the activating plate continues to move along the axis YY′, the flap position does not change.

We also see that it is possible to adjust as required the respective lengths of the longitudinal sections and the angle A. FIGS. 6a, 6b, 6c and 6d show, by way of example, possible shapes of guide slots. These various arrangements are then used to control the sequence and kinematics of the opening and closing of the flaps. As can be seen from these figures, the lengths l₁ and/or 1₂ of the longitudinal sections may be zero.

For example, in a non-limiting way, a first flap can be opened immediately when the vehicle starts, then the other three flaps can be opened in sequence depending on the engine temperature. These particular kinematics also have the advantage of minimizing the forces on the motorized pulley, since only one flap opens at a time. Each of the flaps can also be opened (or closed) successively by completely opening (or completely closing) a flap before starting to open (or close) the next flap.

We could also imagine a ramp which is not straight, with a variable angle A, to adjust the speed at which the flaps are opened or closed.

As a result of these controlled variations, the finger of the set of link rods circulating in the guide slot will cross the ramp 173 between two specific positions of the activating plate and at a speed which is directly proportional to the value of the angle A.

The guide slots disposed on the upper activating plate and on the lower activating plate and intended to drive a given flap obviously have longitudinal sections 171 and 172 of the same length and ramps forming the same angle with the main direction.

FIG. 4 shows the sets of link rods, 141, 142, 143, 144 associated respectively with the flaps 11, 12, 13, 14. All these sets of link rods are identical and operate according to the same principle. The set of link rods 141 includes a primary link rod 141a mounted on the upper edge 110 of the flap 11 using a hinge pin 161 whose axis is substantially vertical. This primary link rod is itself connected using a pin 162 to a secondary link 141b carrying a finger 151 engaging with the guide slot 121.

On crossing the ramp 173 of the guide slot 121, the finger 151 drives the secondary link rod 141b which in turn drives the primary link rod and causes the flap 11 to deploy or retract.

When the set of flaps includes an upper activating plate and a lower activating plate, the sets of link rods associated with the lower activating plate are mounted on the lower edge 111 of the flaps as shown on FIG. 5.

For reasons of protection and aesthetics, it may be useful to arrange the chassis 3 so that the sets of link rods are isolated from external aggressions. Under these conditions, the pin 161 crosses the chassis 3 and runs in a circular rail 180, as shown on FIG. 1.

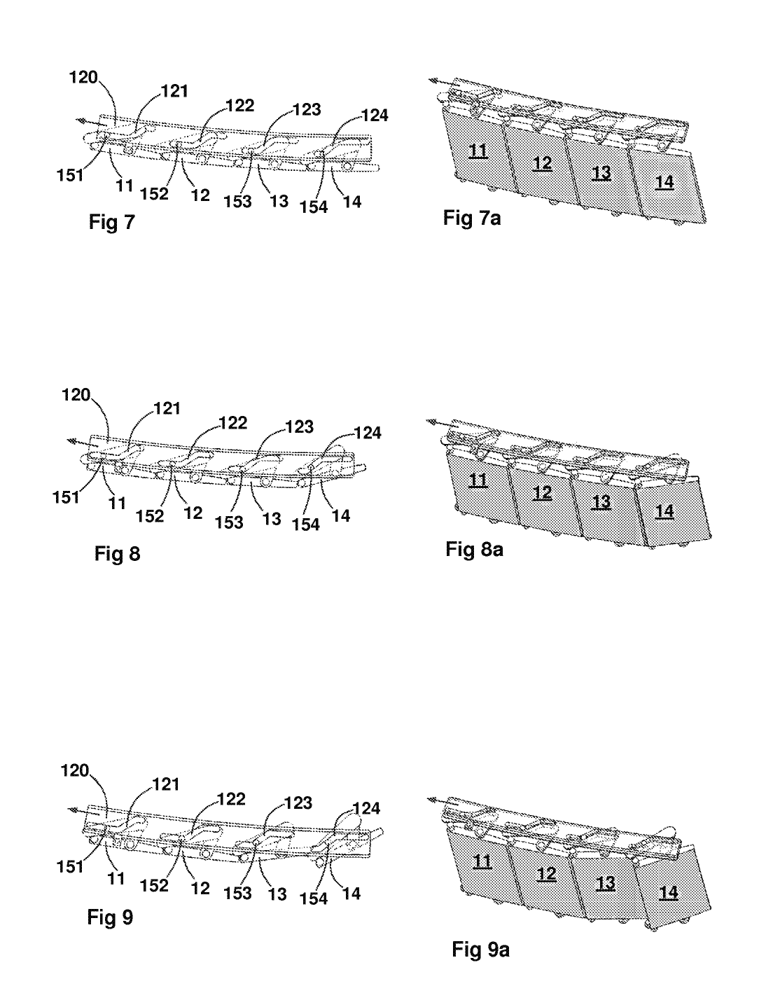

FIGS. 7/7a and after show possible kinematics of the flaps opening in sequence.

FIGS. 7 and 7a show the activating plate 120 in an end position in which the set of flaps is in the closed position. All the guide fingers are positioned in the longitudinal section 171 of their respective guide slots.

When the activating plate starts its translational movement along the axis YY′, moving towards the outer side of the mechanism (see arrow), the finger 154 enters the ramp of the guide slot 124 and the flap 14 starts to open. This is shown on FIGS. 8/8a. The flaps 11, 12 and 13 remain in the closed position.

FIGS. 9/9a show the finger 154 which continues to move in the ramp of the guide slot 124 so as to continue the opening movement of the flap 14. The finger 153 then enters the ramp of the guide slot 123. The flap 13 opens slightly.

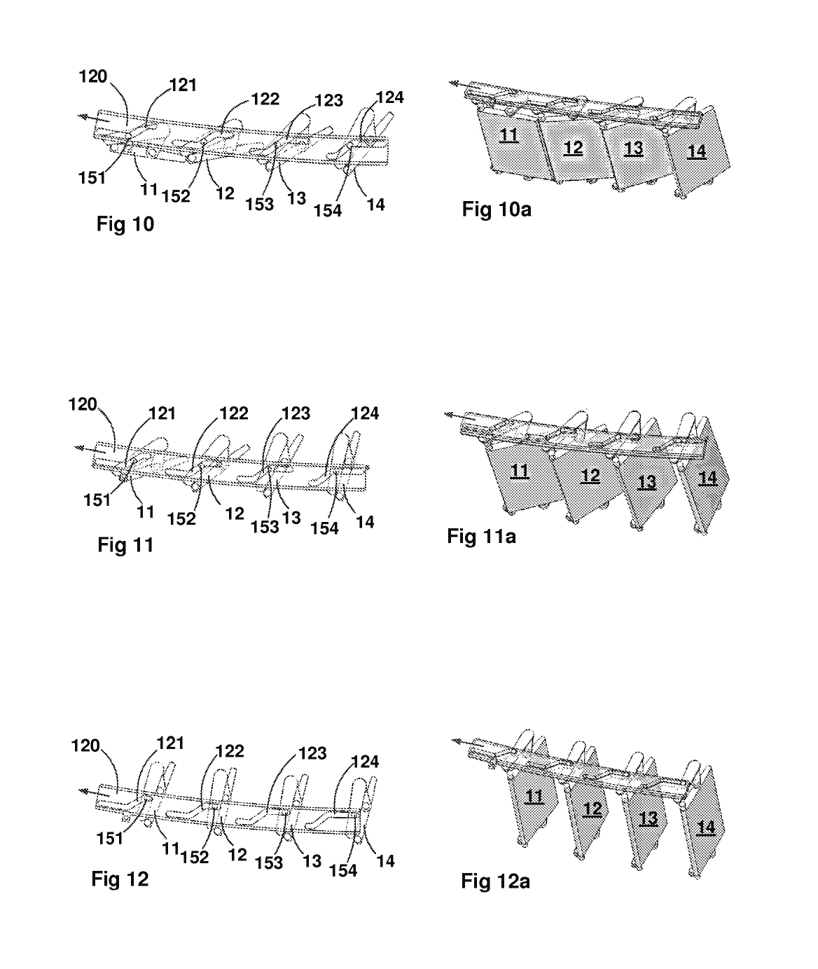

FIGS. 10/10a show the position of the activating plate in which the flap 14 completes its opening movement, while the flap 13 is half-open and the flap 12 is just starting to open. The flap 11 is still completely closed.

FIGS. 11/11a show the flap 14 completely open, and the flaps 11, 12 continuing to open.

When the activating plate 120 reaches its other end position, all the flaps 11, 12, 13 and 14 are in the open position. All the fingers 151, 152, 153 and 154 are then disposed in the longitudinal section 172 of their respective guide slots, as shown on FIGS. 12 and 12a.

As has already been mentioned in the foregoing, the movements of the activating plates 130, 220 and 230, and the flap opening and closing movements can be deduced mutatis mutandis using the explanations provided above describing more specifically the movement of the upper activating plate 120 of the first set of flaps 1.

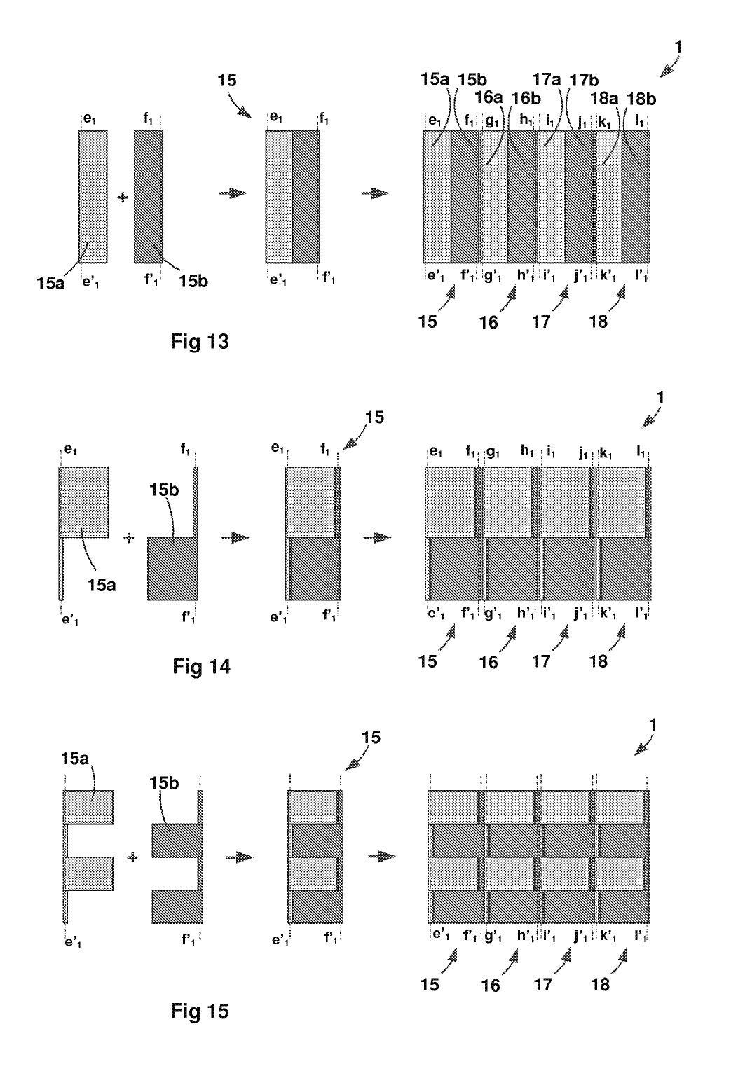

FIGS. 13, 14 and 15 describe one of the possible adaptations of the maneuvering device according to the invention, wherein a set of flaps is formed of one or more pairs respectively 15, 16, 17 and 18 of half-flaps, respectively 15a, 15b, 16a, 16b, 17a, 17b, 18a, 18b. Each pair of half-flaps is itself formed of a first half-flap and a second half-flap each pivoting about an axis respectively e₁e₁e′₁, f₁f′₁, g₁g′₁, h₁h′₁, i₁i′₁, j₁j′₁, k₁k′₁, l₁l′₁, in opposite directions to each other.

Each half-flap includes one or more panels disposed so that when the pair of half-flaps is in the closed position, the panels of the first half-flap hide a surface complementary to the surface hidden by the panels of the second half-flap. Generally, and for aesthetic reasons, each half-flap hides half of the surface hidden by the pair of half-flaps.

The panels may have different shapes depending on the style effect required. The pair of half-flaps illustrated on FIG. 13 comprises half-flaps each formed of two vertical panels both deployed over the full height of the half-flap and each occupying half of the surface hidden by the pair of half-flaps.

The pair of half-flaps illustrated on FIG. 14 comprises two half-flaps whose panels hide respectively the upper half and the lower half of the total surface hidden by the pair of half-flaps.

The pair of half-flaps shown on FIG. 15 illustrates another possible configuration wherein the first half-flap 15a comprises two separate panels hiding the first and third upper quarters of the surface hidden by the pair of half-flaps, and wherein the second half-flap 15b also comprises two separate panels hiding respectively the second and fourth lower quarters of the surface hidden by the pair of half-flaps 15. The two half-flaps 15a and 15b each hide complementary and substantially equal surfaces whose sum represents the total surface hidden by the pair 15. This arrangement allows the various sets formed by placing the pairs of half-flaps next to each other to open in a “checkerboard” pattern.

Similarly, in the above examples, the panels of the half-flaps have substantially equal surfaces. This configuration is not limiting, however, and it is quite possible to design flaps having panels of different shapes and different surfaces, arranged to hide the entire surface when the pair of half-flaps is in the closed position.

The first half-flaps, respectively 15a, 16a, 17a and 18a of a set 1, are driven in rotation by the upper activating plate connected to the first drive cable, and the second half-flaps are driven in rotation by the lower activating plate also connected to the first drive cable when said first drive cable makes a closed loop along the upper and lower edges of the pairs of half-flaps.

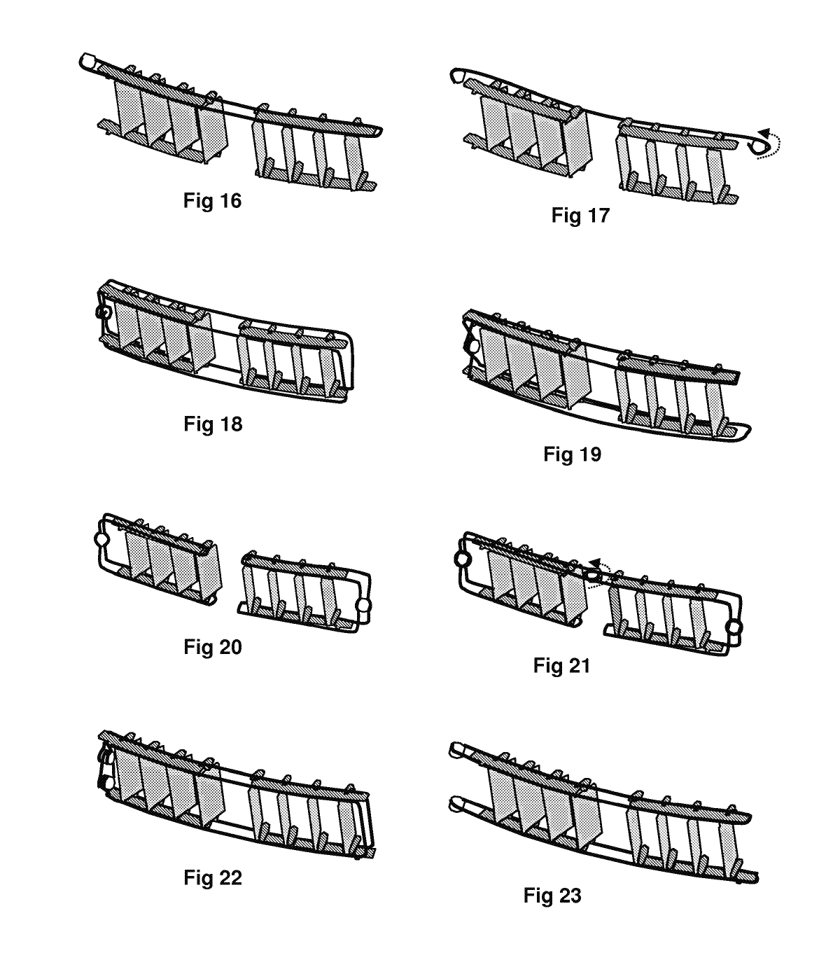

FIGS. 16 to 23 describe possible arrangements of the drive and of the circulation of the one or more drive cables around the sets of flaps.

FIG. 16 shows the simplest case wherein a single drive cable circulates in a closed loop along the upper edges of the flaps. Each of the sets of flaps comprises a single upper activating plate driving in rotation the flaps in opposite directions. The same result can be achieved when the drive cable circulates in a closed loop along the lower edges of the flaps.

FIG. 17 illustrates the case wherein the drive cable is connected by its first end to a drive means pulling the cable in one direction, and by its second end to an elastic return means pulling the cable back in the other direction. The drive means may be formed indifferently by a motorized pulley as described above or by an actuator or by an element with electrically-activated shape memory. This alternative solution is especially advantageous when the flaps have to be closed if there is no electric current at the drive pulley, or alternatively when, in emergency, the flaps have to be closed in a very short time.

FIG. 18 illustrates the case wherein the maneuvering device comprises two separate drive cables each forming a closed loop circulating around the upper and lower parts of the sets of flaps and each driven by a single motorized pulley. This case corresponds to that used as a basis for this description.

FIG. 19 illustrates the case wherein the same drive cable makes two complete turns around the flaps, crossing itself twice, and circulating on the upper and lower parts of the sets of flaps. This configuration achieves the same effects as those achieved with a device comprising two drive cables and shown on FIG. 18. The first turn of the cable around the flaps is equivalent to the first drive cable, and the second turn of the cable around the flaps is equivalent to the second drive cable.

FIG. 20 illustrates the case wherein each flap of each set is set in rotation by its own drive cable, each driven by its own drive pulley.

FIGS. 21 and 22 are improvements of the case shown on FIG. 21 wherein the speeds and positions of the two drive cables are synchronized by a central pulley as shown on FIG. 21, or wherein a drive cable performs a full turn around the motorized pulley of the other drive cable as shown on FIG. 22.

FIG. 23 illustrates the case wherein the upper activating plates are driven in translation by a first drive cable coupled to a first motorized pulley, and wherein the lower activating plates are driven by a second cable drive coupled to a second motorized pulley. Movement of the cables is synchronized through the use of the link rods and the flaps.

1. A device for maneuvering one or more sets of flaps comprising:
the one or more sets of flaps formed of one or more flaps, each flap pivoting about an axis of rotation (a₁a₁′, d₁d₁′, a₂a₂′, b₂b₂′, c₂c₂′, d₂d₂′) mounted on a chassis;
the one or more flaps of the one or more sets of flaps being set in rotation by at least one activating plate that moves in translation between two end positions along a linear path located in a plane substantially perpendicular to the axes of the flaps and forming a main direction;
said activating plate having guide slots, each of the guide slots engaging with a finger disposed on a set of link rods mounted on an upper edge and/or a lower edge of each of the one or more flaps of said one or more sets of flaps;
wherein by the one or more activating plates are driven in translation by at least one drive cable forming a closed loop and circulating along the lower edges and/or upper edges of the one or more flaps such that the movement of an activating plate between said end positions in one direction and in an opposite direction causes each of the one or more flaps of said one or more sets of flaps to open and close respectively.

2. The device according to claim 1, wherein each guide slot comprises two linear longitudinal sections parallel to the main direction, separated from each other by a given non-zero value, and connected to each other by a transverse section forming a ramp making a given angle with said main direction.

3. The device according to claim 2, wherein positions in the main direction and given angles of inclination of the ramps of each of the guide slots are arranged so that each of the fingers engages in the ramp of the guide slot with which it cooperates between two positions of the activating plate defined beforehand for each of the one or more flaps of one of the one or more sets of flaps, such that the one or more flaps of said one or more sets of flaps open and close in a predetermined order.

4. The device according to claim 2, wherein a set of link rods is formed of a primary link rod hinged about a first pin mounted on the upper edge and/or lower edge of one of the flaps, and of a secondary link rod supporting the finger and connected to the primary link rod by a hinge pivoting freely about a second pin, the first and second hinge pins of the link rods being substantially parallel to the axis of rotation of the flap on which the set of link rods is mounted.

5. The device according to claim 1, wherein the activating plate moves between its two end positions along a linear path having a radius of curvature.

6. The device according to claim 5, wherein the activating plate also has a radius of curvature identical to that of the path on which it circulates.

7. The device according to claim 1, wherein the one or more drive cables perform at least one full turn in a given direction around one or more motorized pulleys, such that rotating one or more of said motorized pulleys drives in translation one or more activating plates.

8. The device according to claim 1, wherein the one or more flaps of the one or more sets of flaps are set in rotation by an upper activating plate and a lower activating plate moving in the main direction, and each cooperating with sets of link rods respectively connected to the upper edge and the lower edge of each of the flaps of each of said one or more sets of flaps.

9. The device according to claim 8, wherein the upper activating plate of one of the one or more sets of flaps and the lower activating plate of the same set of flaps are connected to a single drive cable or to a first drive cable and a second drive cable such that, when the one or more motorized pulleys are set in rotation, the upper activating plate and the lower activating plate of said same set of flaps circulate in the same direction in the main direction.

10. The device according to claims 1, comprising two sets of flaps separate from each other, each of the flaps of one of the two sets of flaps pivoting on its respective axis in a direction of rotation opposite to the direction of rotation of the flaps of the other one of the two sets of flaps.

11. The device according to claims 1, wherein one of the sets of flaps is formed of one or more pairs of half-flaps each formed of a first half-flap and a second half-flap each pivoting about an axis in opposite directions to each other, each half-flap comprising one or more panels arranged such that, when the pair of half-flaps is in the closed position, the panels of the first half-flap hide a surface complementary to the surface hidden by the panels of the second half-flap.

12. The device according to claim 11, wherein the first half-flaps of the one of the sets of flaps formed of pairs of half-flaps are driven by the upper activating plate, and the second half-flaps of the one of the sets of flaps formed of pairs of half-flaps are driven in rotation by the lower activating plate.

13. The device according to claim 3, wherein a set of link rods is formed of a primary link rod hinged about a first pin mounted on the upper edge and/or lower edge of the flap, and of a secondary link rod supporting the finger and connected to the primary link rod by a hinge pivoting freely about a second pin, the first and second hinge pins of the link rods being substantially parallel to the axis of rotation of the flap on which the set of link rods is mounted.
